(19) United States
(12) Patent Application Publication
(10) Pub. No.: US 2025/0357998 A1
(43) Pub. Date: Nov. 20, 2025

(54) APPLICATION OF PRIORITIZING TERRESTRIAL NETWORK FREQUENCIES FROM THE BROADCAST OF NON-TERRESTRIAL NETWORK FOR USER EQUIPMENT

(71) Applicant: MEDIATEK Inc., Hsinchu City (TW)

(72) Inventors: Cyril Valadon, Cambridge (GB); Keng-Ming HUANG, Hsinchu City (TW); Shan Qing, San Jose, CA (US); Wei-Sheng YIN, Hsinchu City (TW); Feng-Mao CHAN, Hsinchu City (TW); Nien-Teh HSU, Hsinchu City (TW); Abdelkader Medles, Cambridge (GB); Kuo-Chun LEE, San Jose, CA (US)

(21) Appl. No.: 18/667,430

(22) Filed: May 17, 2024

(51) Int. Cl. H04B 7/185

(52) U.S. Cl. CPC H04B 7/18513

(57) ABSTRACT

In an aspect of the disclosure, an apparatus is provided. The apparatus may be a user equipment (UE). In certain configurations, the UE receives a broadcast from a base station of a Non-Terrestrial Network (NTN). The broadcast from the base station of the NTN includes information of a plurality of frequencies of a terrestrial network (TN). The UE prioritizes the plurality of frequencies of the TN.

### TECHNICAL FIELD

The disclosure relates in general to communication systems, and more particularly, to techniques of methods and apparatuses about schemes to have an application of prioritizing terrestrial network (TN) frequencies from the broadcast of non-terrestrial network (NTN) for user equipment (UE).

### BACKGROUND

5G non-terrestrial network (NTN) cell (or base station) can broadcast information for configuring neighbor terrestrial network (TN) frequencies of 5G New Radio (NR) or 4G Long Term Evolution (LTE) neighbor cells, respectively. These frequencies can configure user equipment (UE) to measure neighbor NR/LTE frequencies for idle/inactive mode cell reselection. Thus, there are needs for applying these frequencies to UE effectively and prioritizing these frequencies based on the proximity of NR/LTE neighbor cells with UE.

### SUMMARY

The present disclosure describes techniques for prioritizing terrestrial network (TN) frequencies from the broadcast of non-terrestrial network (NTN) for user equipment (UE).

The first aspect of the present disclosure features a method of wireless communication of a user equipment (UE). The method comprises receiving a broadcast from a base station of a Non-Terrestrial Network (NTN), which the broadcast from the base station of the NTN includes information of a plurality of frequencies of a terrestrial network (TN). The method also comprises prioritizing the plurality of frequencies of the TN.

In some implementations according to the first aspect of the present disclosure, prioritizing the plurality of frequencies of the TN comprises receiving a message from the base station of the NTN, which the message includes a list of the plurality of frequencies of the TN corresponding to a location of UE obtained by the base station of the NTN, and determining the list of the plurality of frequencies of the TN in the message as high priority.

In some implementations according to the first aspect of the present disclosure, prioritizing the plurality of frequencies of the TN comprises receiving a message from the base station of the NTN, wherein the message includes a mask for the information of the plurality of frequencies of the TN in the broadcast from the base station of the NTN, which the mask is based on a subset of the plurality of frequencies of the TN in the broadcast in a location of UE obtained by the base station of the NTN, and determining the subset of the plurality of frequencies of the TN as high priority according to the mask.

The second aspect of the present disclosure features a method of wireless communication of a base station of a NTN. The method comprises sending a broadcast to a UE, which the broadcast from the base station of the NTN includes information of a plurality of frequencies of a TN. The method also comprises obtaining a location of the UE. The method also comprises sending a message to the UE, wherein the message indicates a priority of the plurality of frequencies of the TN for the UE, based on the location of the UE.

In some implementations according to the second aspect of the present disclosure, the message indicating the priority of the plurality of frequencies of the TN for the UE comprises a prioritized list of the plurality of frequencies of the TN corresponding to the location of UE obtained by the base station of the NTN.

In some implementations according to the second aspect of the present disclosure, the message indicating the priority of the plurality of frequencies of the TN for the UE comprises a mask for the information of the plurality of frequencies of the TN in the broadcast. The mask is based on a subset of the plurality of frequencies of the TN in the broadcast in the location of UE obtained by the base station of the NTN.

In some implementations according to the second aspect of the present disclosure, the message indicating the priority of the plurality of frequencies of the TN for the UE comprises prioritized frequencies in the location of UE, and deprioritized frequencies not in the location of UE.

In some implementations according to the first and the second aspect of the present disclosure, the broadcast includes at least 64 frequencies of the TN.

The third aspect of the present disclosure features an apparatus for wireless communication. The apparatus is a UE. The apparatus comprises a memory and at least one processor coupled to the memory. The at least one processor is configured to receive a broadcast from a base station of a NTN. The broadcast from the base station of the NTN includes information of a plurality of frequencies of a TN. The at least one processor is also configured to prioritize the plurality of frequencies of the TN.

In some implementations according to the first aspect or the third aspect of the present disclosure, prioritizing the plurality of frequencies of the TN comprises detecting a plurality of base stations according to the plurality of frequencies of the TN in a search, and determining a subset of the plurality of frequencies of the TN corresponding to a detected subset of the plurality of base stations in the search as high priority.

In some implementations according to the first aspect or the third aspect of the present disclosure, prioritizing the plurality of frequencies of the TN comprises matching connected mode measurement frequencies configured in the UE to the plurality of frequencies of the TN, and determining a subset of the plurality of frequencies of the TN matching the connected mode measurement frequencies configured in the UE as high priority.

In some implementations according to the first aspect or the third aspect of the present disclosure, prioritizing the plurality of frequencies of the TN comprises determining a subset of the plurality of frequencies of the TN corresponding to frequencies of stations last visited by UE, of the TN as high priority.

In some implementations according to the first aspect or the third aspect of the present disclosure, prioritizing the plurality of frequencies of the TN comprises calculating a Doppler shift of the base station of the NTN, and determining the Doppler shift is small than a threshold. Upon determining Doppler shift is small than the threshold, deprioritizes newly added frequencies in the broadcast from the base station of the NTN.

In some implementations according to the first aspect or the third aspect of the present disclosure, prioritizing the plurality of frequencies of the TN comprises calculating an alignment in direction between a displacement of the base station of the NTN and a displacement from the base station of the NTN to the UE, and determining the base station of the NTN meeting a leaving condition according to the alignment in direction. Upon determining the base station of the NTN meeting the leaving condition, deprioritizes newly added frequencies in the broadcast from the base station of the NTN.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1 is a diagram illustrating an example procedure between an UE and a NTN gNB.

FIG. 2 is a diagram illustrating a movement of NTN gNB coverage corresponding to TN NR/LTE cells.

FIG. 3 illustrates examples of increasing max frequencies of SIB4 and SIB5 to a larger value.

FIG. 4 is a diagram illustrating an example procedure between an UE, a NTN gNB, an AMF and a LMF.

FIG. 5 is a diagram illustrating another example procedure between an UE, a NTN gNB, an AMF and a LMF.

FIG. 6 is a diagram illustrating a movement of NTN gNB coverage corresponding to TN NR/LTE cells and user equipments.

FIG. 7 is a diagram illustrating a movement of NTN gNB related to user equipments.

FIG. 8 is a flow chart of a method (process) for wireless communication of a UE.

FIG. 9 is a flow chart of a method (process) for wireless communication of a base station of NTN.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

The terms “comprise,” “comprising,” “include,” “including,” “has,” “having,” etc. used in this specification are open-ended and mean “comprises but not limited.” The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative embodiments but, like the illustrative embodiments, should not be used to limit the present disclosure. The elements included in the illustrations herein may not be drawn to scale.

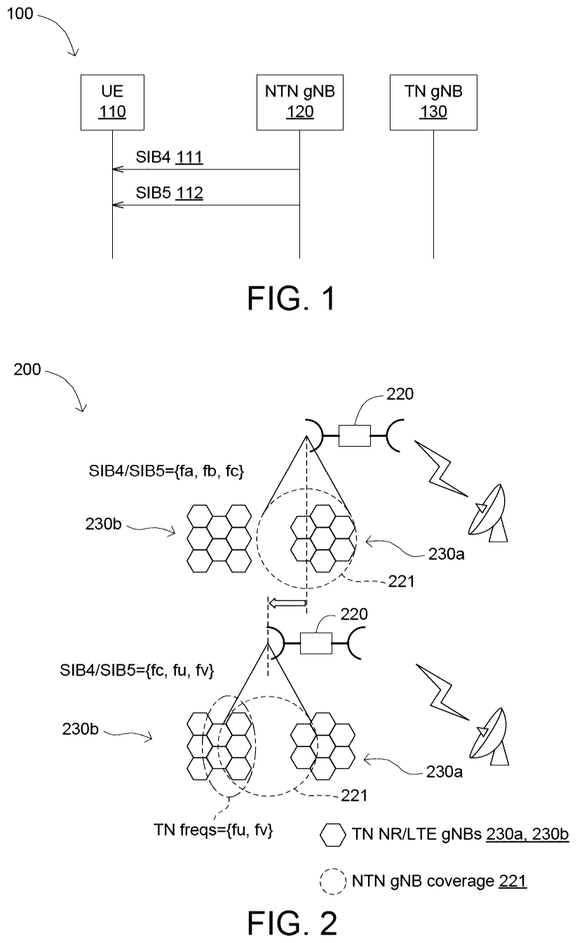

FIG. 1 is a diagram illustrating an example procedure 100 between an UE 110 and a NTN gNB 120. The UE 110 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. Examples of UEs 110 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 110 may be referred to as IoT devices (e.g., parking meter, gas pump, toaster, vehicles, heart monitor, etc.).

The gNB of NTN gNB 120 or TN gNB 130 may also be referred to as a base station, cell, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology, of the Non-Terrestrial Network (NTN) or the Terrestrial Network (TN). The NTN gNB comprises satellite and ground station parts.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

5G non-terrestrial network (NTN) gNB 120 can broadcast, such as SIB4 111 or SIB5 112 (System Information Block, SIB), for configuring neighbor terrestrial network (TN) frequencies of 5G New Radio (NR) or 4G Long Term Evolution (LTE) neighbor cells, respectively (such as frequencies of TN gNB 130). These frequencies can configure UE 110 to measure neighbor NR/LTE frequencies of TN gNB 130 for idle/inactive mode cell reselection. Those frequencies may be varied corresponding to the movement of the NTN gNB 120 while TN gNB 130 within the coverage of the NTN gNB 120 varying.

FIG. 2 is a diagram illustrating a movement of NTN gNB coverage 221 corresponding to TN NR/LTE gNBs 230a, 230b. As discussed above, broadcasted TN neighbor frequencies from NTN gNB 220, which is a non-geo-stationary satellites, may be changed due to the movement of the NTN gNB 220. For example, if NTN uses a LEO (Low Earth Orbit) or MEO (Mid Earth Orbit) satellite, neighbor TN frequencies can change due to the movement of satellite, such as changing from frequencies {fa, fb, fc} in SIB4/SIB5 (SIB4/SIB5={fa, fb, fc}) of TN NR/LTE gNBs 230a, to frequencies {fc, fu, fv} in SIB4/SIB5 (SIB4/SIB5={fc, fu, fv}) corresponding to the new TN frequencies {fu, fv} of TN NR/LTE gNBs 230b due to the movement of NTN gNB coverage 221, as shown in FIG. 2. To change neighbor TN frequencies in SIB4 and SIB5 from frequencies {fa, fb, fc} (corresponding to TN NR/LTE gNBs 230a within the NTN gNB coverage 221) to frequencies {fa, fu, fv} (corresponding to part of TN NR/LTE gNBs 230a and part of TN NR/LTE gNBs 230b within the NTN gNB coverage 221), the NTN gNB 220 can use SIB modification procedure in which the NTN gNB 220 first sends Short Message with command “system InfoModification =1”, followed by a new version of SIB4 and SIB5 with updated neighbor TN frequencies (such as frequencies {fa, fu, fv}).

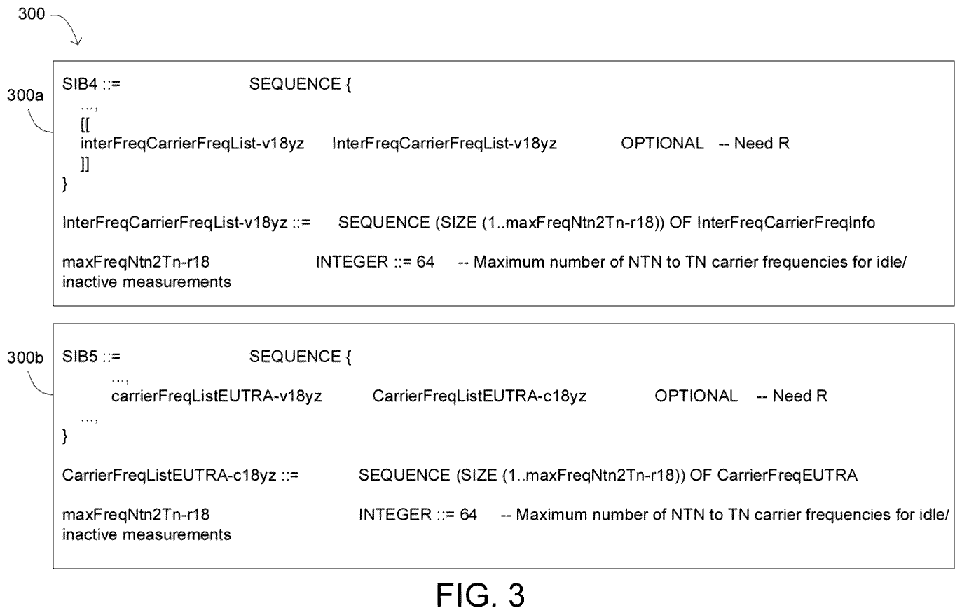

Due to the broad coverage of NTN gNB of non-geo-stationary satellites, such as LEO or MEO satellite, the number of neighbor TN frequencies, which is defaulted to 8 max in current SIB4/SIB5 standards, may be insufficient to represent the frequencies of TN gNBs within the broad coverage of NTN gNB. FIG. 3 illustrates examples 300a, 300b, of increasing max frequencies of SIB4 and SIB5 to a larger value. As shown in examples 300a and 300b, the maximum number of NTN to TN carrier frequencies for idle/inactive measurements can be modified to 64 in SIB4 and SIB5, respectively.

With the increasing maximum number of NTN to TN carrier frequencies in SIB4 and SIB5, which may be received by the UE, techniques for prioritizing those received frequencies for UE are provided according to implementations of the present disclosure, to process those received frequencies.

In some implementations, since some neighbor frequencies in SIB4 and SIB5 are not within the coverage of UE, the UE can prioritize subset of frequencies with any of the following means to measure in idle/inactive mode (e.g. non-prioritized frequencies can be ignored in measurement). In some implementations, if UE can detect some TN gNB (or cell) in the 1st run of search, its frequency will be considered as high priority to continue measurement in idle/inactive mode. If there is no cell detected in the 1st run of search, UE suspends search/measurement for some time.

In some implementations, if UE is configured with connected mode measurement frequencies (such as measObject), these frequencies can be considered as high priority to measure later in idle/inactive mode. Furthermore, if UE can detect some TN gNB (or cell), its frequency will be considered as even higher priority to measure later in idle/inactive mode.

In some implementations, UE can store frequencies of last visited serving frequency of 5G/4G TN gNB (or cell) and the neighbor frequencies of SIB4/SIB5 of last visited 5G/4G TN cells, and UE considers these frequencies as high priority to measure in idle/inactive mode.

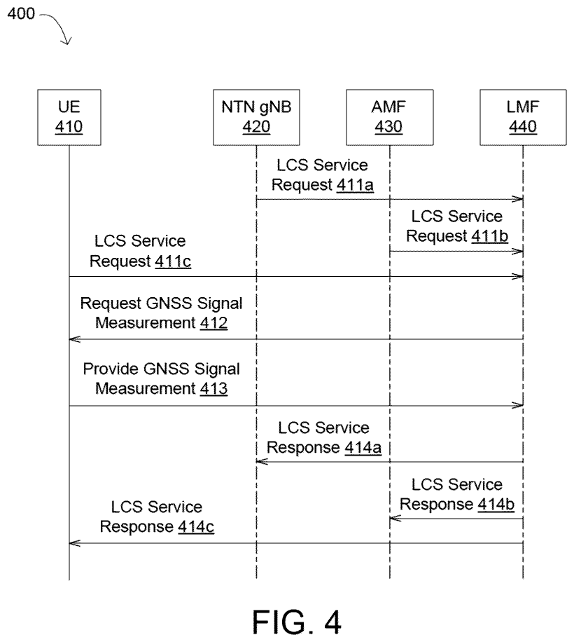

Addition to the techniques above according to implementations of the present disclosure, techniques based on different mechanisms for prioritizing NTN to TN carrier frequencies in SIB4 and SIB5 for UE, will be further discuss referring to FIGS. 4 to 9 as following.

FIG. 4 is a diagram illustrating an example procedure 400 between an UE 410, a NTN gNB 420, an AMF 430 and a LMF 440. In some implementations, NTN to TN carrier frequencies in SIB4 and SIB5 can be prioritized according to the location of UE 410. In some implementations, upon network request, after AS (Access Stratum) security is established in connected mode, UE 410 should report its coarse location information (most significant bits of the GNSS (Global Navigation Satellite System) coordinates, ensuring an accuracy in the order of 2 km) to the NG-RAN (Next Generation Radio Access Network), such as to LMF (location management function (LMF) 440, if available (such as process 413). In some implementations, a method to get location of UE 410 is assisted UE 410 GNSS measurement by LMF 440, which LMF 440 can request UE 410 to provide GNSS signal measurement (such as process 412), and LMF 410 can calculate the location of UE 410. Requests of the location of UE 410 (also referred to location service, LCS) can be initiated by NTN gNB 420 (such as process 411a), AMF (Mobility Management Function) 430 (such as process 411b), or UE 410 (such as process 411c). Then, LCS service can response to NTN gNB 420 (such as process 414a), AMF (Mobility Management Function) 430 (such as process 414b), or UE 410 (such as process 414c), accordingly.

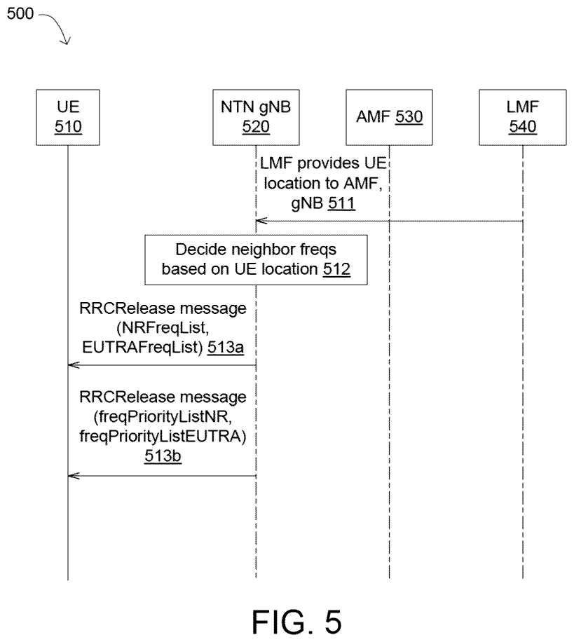

FIG. 5 is a diagram illustrating another example procedure 500 between an UE 510, a NTN gNB 520, an AMF 530 and a LMF 540. Since AMF 530/NTN-gNB 520 can obtain the location of UE 510 location (such as process 511) as discussed above, NTN-gNB 520 can decide TN neighbor frequencies for UE 510 based on the location of UE 510. In some implementations, NTN-gNB 520 can send subset of SIB4/SIB5 frequencies according to the location of UE 510 in RRCRelease message (such as process 513a). The RRCRelease message can signal a list of NR and LTE frequencies (such as NRFreqList or EUTRAFreqList in FIG. 5) in the location of UE 510, or the RRCRelease message can indicate a mask of SIB4/SIB5 with a “bit=1” of for the frequency in the location of UE 510.

In some implementations, such as process 513b of FIG. 5, RRCRelease message can include “freqPriorityListNR” and/or “freqPriorityListEUTRA” which indicate for increasing priority of frequencies in the location of UE 540 and/or decreasing priority of frequencies not in the location of UE 540, based on the location of UE 540.

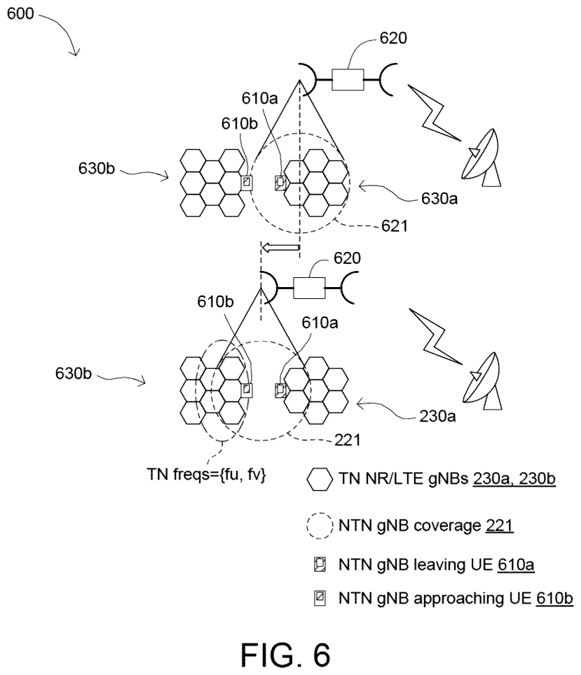

FIG. 6 is a diagram illustrating a movement of NTN gNB coverage 621 corresponding to TN NR/LTE gNBs 630a, 630b and UEs 610a, 610b. The NTN gNB 620 can add new TN frequencies in SIB4/SIB5 when the NTN gNB 620 enters a new set of TN NR/LTE gNBs, such as TN frequencies {fu, fv} corresponding to TN NR/LTE gNBs 630b in FIG. 6. In some implementations, the UE 610a can deprioritize or ignore the newly added TN frequencies in SIB4/SIB5 if the NTN gNB 620 is leaving UE 610a. In some cases, leaving from or approaching to UEs 610a or 610b, of NTN gNB 620 can be determined by the following. Upon determining NTN gNB 620 is approaching to UEs 610a or 610b, detected Doppler shift (Δf/f) of NTN gNB 620 is positive (for example, Δf/f>0). Upon determining NTN gNB 620 is leaving from UEs 610a or 610b, detected Doppler shift (Δf/f) of NTN gNB 620 is negative (for example, Δf/f<0). In some implementations, to avoid false alarm, leaving condition of NTN gNB 620 detected by the UEs 610a or 610b, can be modified by the following: NTN gNB 620 is leaving from UEs 610a or 610b, detected Doppler shift (Δf/f) of NTN gNB 620 is small than a negative threshold, such as Δf/f<−TH or Δf<−TH.

Additionally, in some implementations, filtering a few samples of Doppler shift can reduce signal fluctuation and noise effect. For example, the UE 610a can ignore newly added TN frequencies {fu, fv} with negative Doppler shift of NTN gNB 620 while UE 610b with positive Doppler shift of NTN gNB 620 cannot ignore, as shown in FIG. 6.

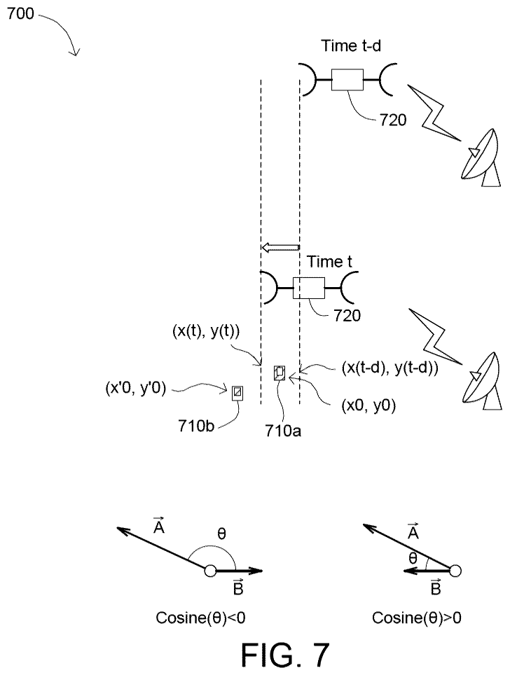

FIG. 7 is a diagram illustrating a movement of NTN gNB 720 related to UEs 710a, 710b. Alternatively, in the example of FIG. 7, leaving from or approaching to UEs 710a or 710b, of NTN gNB 720 can be determined by the following. In some implementations, UEs 710a or 710b can calculate alignment in direction between displacement of NTN gNB 720 of the satellite at two times and displacement from NTN gNB 720 of satellite to UEs 710a or 710b. For example, as shown in FIG. 7, vector \vec{A}=(x(t), y(t))−(x(t−d), y(t−d)) vector \vec{B}=(x(t), y(t))−(x0, y0), wherein (x(t), y(t)) is (latitude, longitude) of NTN gNB 720 of satellite at time t, (x0, y0) (or (x′0, y′0)) is (latitude, longitude) of the UE 710a (or UE 710b) at time t, and d is time delay of two sampled satellite position.

Then Cosine (θ)=\vec{A}·\vec{B}/ (∥\vec{A}∥ ∥\vec{B}∥), wherein “·” is vector inner product, ∥ ∥ is length of vector. In this case, leaving condition of NTN gNB 720 detected by the UEs 710a or 710b, can be determined based on: Cosine (θ)>0 (or Cosine (θ)>TH). For example, the UE 710a meets leaving condition and newly added TN frequencies from NTN gNB 720 (such as those added in SIB4/SIB5) can be ignored.

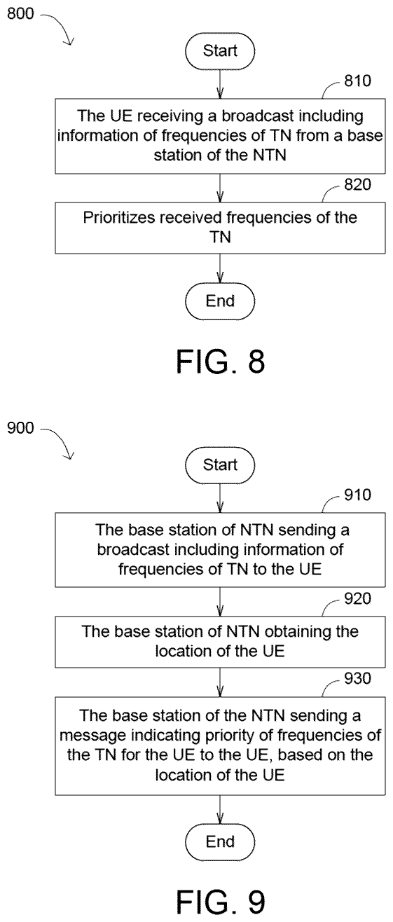

FIG. 8 is a flow chart of a method (process 800) for wireless communication of a UE. In step 810, the UE (such as UE 110, 210, 410, 510, 610a, 610b, 710a and 710b of FIGS. 1, 2, 4, 5, 6 and 7) receives a broadcast (such as SIB4/SIB5 discussed above) from a base station of a NTN (such as NTN gNBs 120, 220, 420, 520, 620 and 720 of FIGS. 1, 2, 4, 5, 6 and 7), which the broadcast from the base station of the NTN includes information of frequencies of TN. In step 820, prioritizes received frequencies of the TN, which may be by the base station of a NTN or the UE, as examples discussed above.

In certain configurations, prioritizing frequencies of the TN comprises detecting base stations according to frequencies of the TN in a search, and determining a subset of frequencies of the TN corresponding to a detected subset of base stations in the search as high priority.

In certain configurations, prioritizing frequencies of the TN comprises matching connected mode measurement frequencies configured in the UE to frequencies of the TN, and determining a subset of frequencies of the TN matching the connected mode measurement frequencies configured in the UE as high priority.

In certain configurations, prioritizing frequencies of the TN comprises determining a subset of frequencies of the TN corresponding to frequencies of stations last visited by UE, of the TN as high priority.

In certain configurations, prioritizing frequencies of the TN comprises receiving a message from the base station of the NTN, wherein the message includes a list of frequencies of the TN corresponding to a location of UE obtained by the base station of the NTN, and determining the list of frequencies of the TN in the message as high priority.

In certain configurations, prioritizing frequencies of the TN comprises: receiving a message from the base station of the NTN, wherein the message includes a mask for the information of frequencies of the TN in the broadcast from the base station of the NTN, wherein the mask is based on a subset of frequencies of the TN in the broadcast in a location of UE obtained by the base station of the NTN, and determining the subset of frequencies of the TN as high priority according to the mask.

In certain configurations, prioritizing frequencies of the TN comprises calculating a Doppler shift of the base station of the NTN, and determining the Doppler shift is small than a threshold. Upon determining Doppler shift is small than the threshold, deprioritizes newly added frequencies in the broadcast from the base station of the NTN.

In certain configurations, prioritizing frequencies of the TN comprises calculating an alignment in direction between a displacement of the base station of the NTN and a displacement from the base station of the NTN to the UE, and determining the base station of the NTN meeting a leaving condition according to the alignment in direction. Upon determining the base station of the NTN meeting the leaving condition, deprioritizes newly added frequencies in the broadcast from the base station of the NTN.

FIG. 9 is a flow chart of a method (process 900) for wireless communication of a base station of NTN (such as NTN gNBs 120, 220, 420, 520, 620 and 720 of FIGS. 1, 2, 4, 5, 6 and 7). In step 910, the base station of NTN sending a broadcast (such as SIB4/SIB5 discussed above) to a UE (such as UE 110, 210, 410, 510, 610a, 610b, 710a and 710b of FIGS. 1, 2, 4, 5, 6 and 7), which the broadcast from the base station of the NTN includes information of frequencies of TN. In step 920, the base station of NTN obtains a location of the UE (as the example of FIG. 4). In step 930, the base station of the NTN sends a message to the UE, wherein the message indicates a priority of frequencies of the TN for the UE, based on the location of the UE (as the example of FIG. 5).

In certain configurations, the message indicating the priority of frequencies of the TN for the UE comprises a prioritized list of frequencies of the TN corresponding to the location of UE obtained by the base station of the NTN.

In certain configurations, the message indicating the priority of frequencies of the TN for the UE comprises a mask for the information of frequencies of the TN in the broadcast, wherein the mask is based on a subset of frequencies of the TN in the broadcast in the location of UE obtained by the base station of the NTN.

In certain configurations, the message indicating the priority of frequencies of the TN for the UE comprises prioritized frequencies in the location of UE, and deprioritized frequencies not in the location of UE.

In certain configurations, the broadcast includes at least 64 frequencies of the TN.

By the techniques of sending the TN frequencies in SIB4/SIB5 and connection release messages, or prioritizing frequencies in idle/inactive mode measurement or in determination of leaving/approaching conditions of NTN gNB by UE according to implementations of present applications, it allows UE to prioritize the frequencies in idle/inactive mode measurement to speed up cell reselection or reduce power consumption while NTN gNB being configured to provide sufficiently large number of TN frequencies.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A method of wireless communication of a user equipment (UE), comprising:
receiving a broadcast from a base station of a Non-Terrestrial Network (NTN), which the broadcast from the base station of the NTN includes information of a plurality of frequencies of a terrestrial network (TN); and
prioritizing the plurality of frequencies of the TN.

2. The method of claim 1, wherein prioritizing the plurality of frequencies of the TN comprises:
detecting a plurality of base stations according to the plurality of frequencies of the TN in a search; and
determining a subset of the plurality of frequencies of the TN corresponding to a detected subset of the plurality of base stations in the search as high priority.

3. The method of claim 1, wherein prioritizing the plurality of frequencies of the TN comprises:
matching connected mode measurement frequencies configured in the UE to the plurality of frequencies of the TN; and
determining a subset of the plurality of frequencies of the TN matching the connected mode measurement frequencies configured in the UE as high priority.

4. The method of claim 1, wherein prioritizing the plurality of frequencies of the TN comprises:
determining a subset of the plurality of frequencies of the TN corresponding to frequencies of stations last visited by UE, of the TN as high priority.

5. The method of claim 1, wherein prioritizing the plurality of frequencies of the TN comprises:
receiving a message from the base station of the NTN, wherein the message includes a list of the plurality of frequencies of the TN corresponding to a location of UE obtained by the base station of the NTN; and
determining the list of the plurality of frequencies of the TN in the message as high priority.

6. The method of claim 1, wherein prioritizing the plurality of frequencies of the TN comprises:
receiving a message from the base station of the NTN, wherein the message includes a mask for the information of the plurality of frequencies of the TN in the broadcast from the base station of the NTN, wherein the mask is based on a subset of the plurality of frequencies of the TN in the broadcast in a location of UE obtained by the base station of the NTN; and
determining the subset of the plurality of frequencies of the TN as high priority according to the mask.

7. The method of claim 1, wherein prioritizing the plurality of frequencies of the TN comprises:
calculating a Doppler shift of the base station of the NTN; and
determining the Doppler shift is small than a threshold,
wherein upon determining Doppler shift is small than the threshold, deprioritizes newly added frequencies in the broadcast from the base station of the NTN.

8. The method of claim 1, wherein prioritizing the plurality of frequencies of the TN comprises:
calculating an alignment in direction between a displacement of the base station of the NTN and a displacement from the base station of the NTN to the UE; and
determining the base station of the NTN meeting a leaving condition according to the alignment in direction,
wherein upon determining the base station of the NTN meeting the leaving condition, deprioritizes newly added frequencies in the broadcast from the base station of the NTN.

9. The method of claim 1, wherein the broadcast from the base station of the NTN includes at least 64 frequencies of the TN.

10. A method of wireless communication of a base station of a NTN, comprising:
sending a broadcast to a UE, which the broadcast from the base station of the NTN includes information of a plurality of frequencies of a TN;
obtaining a location of the UE; and
sending a message to the UE, wherein the message indicates a priority of the plurality of frequencies of the TN for the UE, based on the location of the UE.

11. The method of claim 9, wherein the message indicating the priority of the plurality of frequencies of the TN for the UE comprises a prioritized list of the plurality of frequencies of the TN corresponding to the location of UE obtained by the base station of the NTN.

12. The method of claim 9, wherein the message indicating the priority of the plurality of frequencies of the TN for the UE comprises a mask for the information of the plurality of frequencies of the TN in the broadcast, wherein the mask is based on a subset of the plurality of frequencies of the TN in the broadcast in the location of UE obtained by the base station of the NTN.

13. The method of claim 9, wherein the message indicating the priority of the plurality of frequencies of the TN for the UE comprises prioritized frequencies in the location of UE, and deprioritized frequencies not in the location of UE.

14. The method of claim 9, wherein the broadcast includes at least 64 frequencies of the TN.

15. An apparatus for wireless communication, the apparatus being a UE, comprising:
a memory; and
at least one processor coupled to the memory and configured to:
receive a broadcast from a base station of a NTN, which the broadcast from the base station of the NTN includes information of a plurality of frequencies of a TN; and
prioritize the plurality of frequencies of the TN.

16. The apparatus of claim 15, wherein prioritizing the plurality of frequencies of the TN comprises:
detecting a plurality of base stations according to the plurality of frequencies of the TN in a search;
determining a subset of the plurality of frequencies of the TN corresponding to a detected subset of the plurality of base stations in the search as high priority.

17. The apparatus of claim 15, wherein prioritizing the plurality of frequencies of the TN comprises:
matching connected mode measurement frequencies configured in the UE, to the plurality of frequencies of the TN; and
determining a subset of the plurality of frequencies of the TN matching the connected mode measurement frequencies configured in the UE, as high priority.

18. The apparatus of claim 15, wherein prioritizing the plurality of frequencies of the TN comprises:
determining a subset of the plurality of frequencies of the TN corresponding to frequencies of stations last visited by UE and stored in the memory of the UE, of the TN as high priority.

19. The apparatus of claim 15, wherein prioritizing the plurality of frequencies of the TN comprises:
calculating a Doppler shift of the base station of the NTN; and
determining the Doppler shift is small than a threshold,
wherein upon determining Doppler shift is small than the threshold, deprioritizes newly added frequencies in the broadcast from the base station of the NTN.

20. The apparatus of claim 15, wherein prioritizing the plurality of frequencies of the TN comprises:
calculating an alignment in direction between a displacement of the base station of the NTN and a displacement from the base station of the NTN to the UE; and
determining the base station of the NTN meeting a leaving condition according to the alignment in direction,
wherein upon determining the base station of the NTN meeting the leaving condition, deprioritizes newly added frequencies in the broadcast from the base station of the NTN.
